(19) United States
(12) Patent Application Publication
(10) Pub. No.: US 2023/0074693 A1
(43) Pub. Date: Mar. 9, 2023

(54) SPRAY TRANSFER MOLDED VEHICULAR MATTRESS SUPPORT PLATFORM

(71) Applicant: INTEVA PRODUCTS, LLC, Troy, MI (US)

(72) Inventor: Brian H. Staser, Oxford, MI (US)

(21) Appl. No.: 17/939,094

(22) Filed: Sep. 7, 2022

Related U.S. Application Data
(60) Provisional application No. 63/241,135, filed on Sep. 7, 2021.

(51) Int. Cl. B60N 3/00; B60P 3/38; B29C 43/00

(52) U.S. Cl. CPC B60N 3/008; B60P 3/38; B29C 43/003; B29K 2105/12

(57) ABSTRACT

Disclosed is a method of fabricating a mattress support platform comprising providing a core material; positioning a first fiber-based substrate on a first side of the core material and positioning a second fiber-based substrate on a second side of the core material; spraying an application material to the first and second fiber-based substrates; and molding the application material to form a vehicular mattress support platform. Also disclosed is a mattress support platform comprising a first fiber-based substrate positioned on a first side of a core material and a second fiber-based substrate positioned on a second side of the core material; and a spray applied application material on the first and second fiber-based substrates, the spray applied application material molded to form a vehicular mattress support platform.

### CROSS-REFERENCE TO RELATED APPLICATION

The present application claims priority benefit to a provisional application which was filed on Sep. 7, 2021, and assigned Ser. No. 63/241,135. The entire contents of the foregoing provisional application is incorporated herein by reference.

### BACKGROUND

Exemplary embodiments pertain to the art of mattress supports.

In various vehicles, especially in trucks and commercial vehicles, there is often a need to provide one or more sleeping areas within the vehicle. By way of example, vehicles can often include one or more sleeper bunks or berths so one member of a driving team can rest while the other operates the vehicle, or which allows one or both members of the team to rest when the vehicle is parked.

Some current technologies for mattress supports (e.g., commercial vehicle sleeper cab bunks) range from plywood (e.g., ¾″ plywood), to gas-assisted injection moldings, to vac-formed and heat staked foam filled shells. These technologies produce a range of weights, strengths, and costs. The market is open for an improved fabrication process that can provide lower weight, improved and/or adequate strength, and lower cost.

While a variety of sleeper bunk or berth devices are known, there is a continued need for improved mattress supports. These and other inefficiencies and opportunities for improvement are addressed and/or overcome by the mattress support platforms, assemblies, systems and methods of the present disclosure.

### BRIEF DESCRIPTION

Disclosed is a method of fabricating a mattress support platform comprising providing a core material; positioning a first fiber-based substrate on a first side of the core material and positioning a second fiber-based substrate on a second side of the core material; spraying an application material to the first and second fiber-based substrates; and molding the application material to form a vehicular mattress support platform.

In addition to one or more of the features described above, or as an alternative to any of the foregoing embodiments, the core material is a paper core honeycomb material.

In addition to one or more of the features described above, or as an alternative to any of the foregoing embodiments, the core material has a thickness of from about 20 mm to about 50 mm.

In addition to one or more of the features described above, or as an alternative to any of the foregoing embodiments, the core material has a variable thickness.

In addition to one or more of the features described above, or as an alternative to any of the foregoing embodiments, the first and second fiber-based substrates each have a thickness of from about 0.5 mm to about 3 mm.

In addition to one or more of the features described above, or as an alternative to any of the foregoing embodiments, the core material is a paper core honeycomb material with a pre-determined cell size.

In addition to one or more of the features described above, or as an alternative to any of the foregoing embodiments, the first and second fiber-based substrates are random glass fiber-based substrates or continuous glass fiber-based substrates.

In addition to one or more of the features described above, or as an alternative to any of the foregoing embodiments, the first and second fiber-based substrates are glass fiber-based substrates having variable glass fiber content.

In addition to one or more of the features described above, or as an alternative to any of the foregoing embodiments, the application material comprises a pre-polymer material.

In addition to one or more of the features described above, or as an alternative to any of the foregoing embodiments, the application material comprises urethane.

In addition to one or more of the features described above, or as an alternative to any of the foregoing embodiments, the application material comprises a resin.

In addition to one or more of the features described above, or as an alternative to any of the foregoing embodiments, the application material is compression molded to form the vehicular mattress support platform.

In addition to one or more of the features described above, or as an alternative to any of the foregoing embodiments, the method further comprising curing the application material to form the vehicular mattress support platform.

In addition to one or more of the features described above, or as an alternative to any of the foregoing embodiments, wherein at least a portion of the application material penetrates the first and second fiber-based substrates.

In addition to one or more of the features described above, or as an alternative to any of the foregoing embodiments, the vehicular mattress support platform comprises at least one attachment location for an attachment member.

In addition to one or more of the features described above, or as an alternative to any of the foregoing embodiments, the first and second fiber-based substrates each comprises at least one of glass fibers, carbon fibers, or natural fibers, or a combination thereof.

Also disclosed is a mattress support platform comprising a first fiber-based substrate positioned on a first side of a core material and a second fiber-based substrate positioned on a second side of the core material; and a spray applied application material on the first and second fiber-based substrates, the spray applied application material molded to form a vehicular mattress support platform.

The above described and other features are exemplified by the following figures and detailed description.

Any combination or permutation of embodiments is envisioned. Additional advantageous features, functions and applications of the disclosed mattress support platforms, assemblies and methods of the present disclosure will be apparent from the description which follows, particularly when read in conjunction with the appended figures. All references listed in this disclosure are hereby incorporated by reference in their entireties.

### BRIEF DESCRIPTION OF THE DRAWINGS

The following descriptions should not be considered limiting in any way. With reference to the accompanying drawings, like elements are numbered alike.

Features and aspects of embodiments are described below with reference to the accompanying drawings, in which elements are not necessarily depicted to scale.

Exemplary embodiments of the present disclosure are further described with reference to the appended figures. It is to be noted that the various features, steps, and combinations of features/steps described below and illustrated in the figures can be arranged and organized differently to result in embodiments which are still within the scope of the present disclosure. To assist those of ordinary skill in the art in making and using the disclosed mattress support platforms, assemblies and methods, reference is made to the appended figures, wherein:

FIG. 1 is a top perspective view of an exemplary mattress support platform.

FIG. 2 is a bottom perspective view of an exemplary mattress support platform.

FIG. 3 is a side cross-sectional view of an exemplary mattress support platform.

### DETAILED DESCRIPTION

A detailed description of one or more embodiments of the disclosed apparatus and method are presented herein by way of exemplification and not limitation with reference to the Figures.

Disclosed herein is a mattress support platform. The mattress support platform is suitable for use in a vehicle, particularly a truck, commercial vehicle, recreational vehicle, camping trailer or slide in camper. The mattress support platform offers adequate support for a mattress and a person sleeping on the mattress while also providing substantial weight savings over currently available mattress support platforms. Weight savings lead to greater fuel efficiency.

The exemplary embodiments disclosed herein are illustrative of advantageous mattress support platforms, and systems of the present disclosure and methods/techniques thereof. It should be understood, however, that the disclosed embodiments are merely exemplary of the present disclosure, which may be embodied in various forms. Therefore, details disclosed herein with reference to exemplary mattress support platforms and associated processes/techniques of assembly and use are not to be interpreted as limiting, but merely as the basis for teaching one skilled in the art how to make and use the advantageous mattress support platforms of the present disclosure.

Referring now to the drawings, like parts are marked throughout the specification and drawings with the same reference numerals, respectively. Drawing figures are not necessarily to scale and in certain views, parts may have been exaggerated for purposes of clarity.

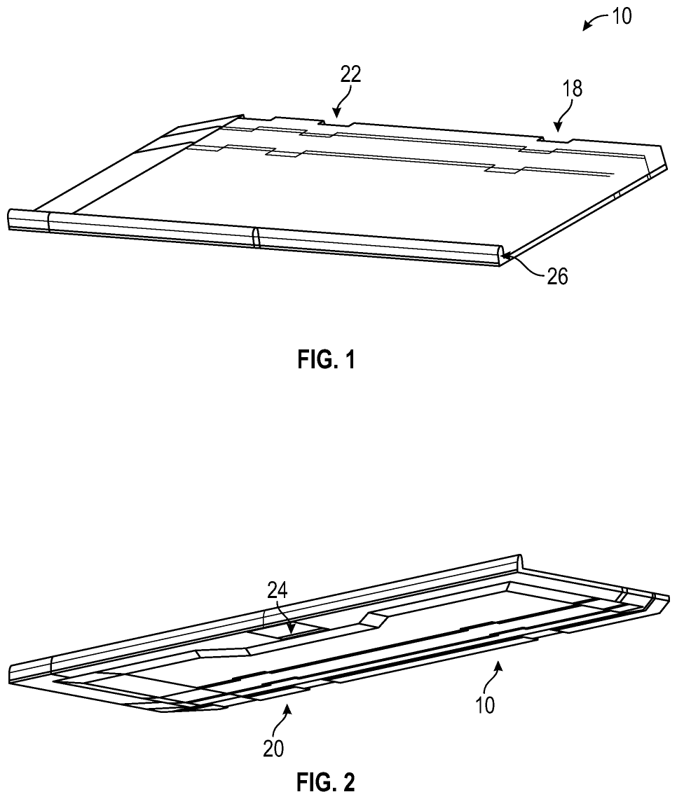

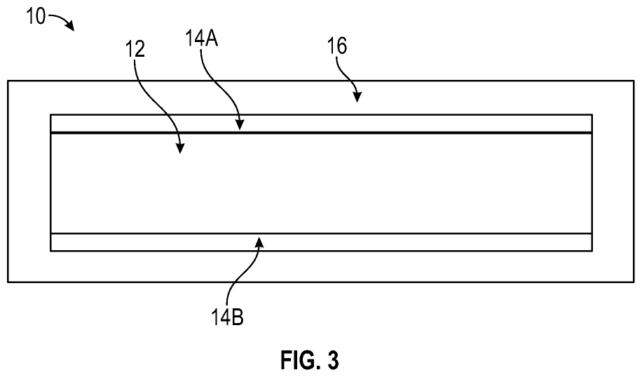

FIG. 1 is a top view of a mattress support platform 10. The mattress support platform 10 may vary in size. The mattress support platform can have an exterior edge that is continuous over at least three sides of the mattress support platform. When a front edge 26 is present, the front edge 26 may replace or supplement the exterior edge of the front side of the mattress support 10.

FIG. 1 shows the front edge 26 of the mattress support platform 10. The front edge 26 helps to retain a mattress on the mattress support platform 10. The front edge 26 may have any desirable height. The front edge 26 may be molded with the mattress support platform 10, or may be attached at a later time.

The mattress support 10 may have at least one attachment location 22 for an attachment member (e.g., a portion of a wall attachment such as a hinge or the like). The mattress support 10 may also have an attachment point for a portion of a closure mechanism 24.

In exemplary embodiments, the present disclosure provides a method of fabricating a mattress support platform 10 comprising providing a core material 12; positioning a first fiber-based substrate 14A on a first side 18 of the core material 12 and positioning a second fiber-based substrate 14B on a second side 20 of the core material 12; spraying an application material 16 to the first and second fiber-based substrates 14A, 14B; and molding the application material 16 to form a vehicular mattress support platform 10.

The present disclosure also provides for a first fiber-based substrate 14A positioned on a first side 18 of a core material 12 and a second fiber-based substrate 14B positioned on a second side 20 of the core material 12; and a spray applied application material 16 on the first and second fiber-based substrates 14A, 14B, the spray applied application material 16 molded to form a vehicular mattress support platform 10.

The core material 12 can be a paper core honeycomb material 12. The core material 12 can have a thickness of from about 20 mm to about 50 mm. It is noted that the core material 12 can have a variable thickness. The core material 12 can be a paper core honeycomb material with a pre-determined cell size. The cell size can be homogeneous or variable.

The first and second fiber-based substrates 14A, 14B can each have a thickness of from about 0.5 mm to about 3 mm. The first and second fiber-based substrates 14A, 14B can be random glass fiber-based substrates or continuous glass fiber-based substrates, with any suitable GSM (gram per square meter) requirement. The first and second fiber-based substrates 14A, 14B can be glass fiber-based substrates having variable glass fiber content. Exemplary fiber-based substrates 14A, 14B include glass fibers, carbon fibers, natural fibers (e.g., cellulose (wood), hemp, jute or the like), or a combination thereof. As such, the first and second fiber-based substrates 14A, 14B can each comprise at least one of glass fibers, carbon fibers, or natural fibers, or a combination thereof.

The application material 16 can comprise a pre-polymer material. The application material 16 can comprise urethane. The application material 16 can comprise a resin.

The application material 16 can be compression molded to form the vehicular mattress support platform 10. It is noted that the application material 16 can also be cured to form the vehicular mattress support platform 10. It is noted that at least a portion of the application material 16 can penetrate the first and second fiber-based substrates 14A, 14B (e.g., during formation of platform 10).

The present disclosure advances the process capabilities of spray transfer molding process to produce/fabricate exemplary mattress support platforms 10 (e.g., bunk trays 10). These advancements can generate one mold that is capable of many advantageous features and functionalities, as discussed below, without limitation.

For example, a support platform 10 (e.g., bunk tray 10) can have a paper core honeycomb 12 with glass fiber mats 14A, 14B top and bottom with spray applied urethane 16 that is compression molded to the desired final part shape and configuration of platform 10.

Again, the honeycomb 12 can be of any cell size or paper thickness.

The glass mats 14A, 14B can be random glass fiber or continuous with any GSM requirement.

The support platforms 10 of the present disclosure can be fabricated with variable thickness honeycomb 12 for a tuned strength distribution.

The support platforms 10 of the present disclosure can be fabricated with variable glass content urethane 16 to tune for strength distribution.

The support platforms 10 of the present disclosure can be fabricated with integrated front edges that have class-A appearance due to in mold filming with either pre-formed film inserts or in process formed film inserts, with the film even crossing the parting line of the mold.

The support platforms 10 of the present disclosure can be fabricated with integrated threaded fasteners or through holes, both in die draw and out of die draw for various component attachment requirements including but not limited to, latches, wire harnesses, air struts, lights, etc.

The support platforms 10 of the present disclosure can be fabricated with through coring to generate flanges internal to the part for attachment of components.

The support platforms 10 of the present disclosure can be fabricated/formed in one tool that addresses a family of different size bunk 10 requirements with inserts in the tool, both for part length and part width, where these inserts can address not only the moving part trim edges but part features.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity and are to be construed to cover both the singular and the plural, unless otherwise indicated herein or clearly contradicted by context. “Or” means “and/or” unless clearly stated otherwise. Reference throughout the specification to “some embodiments”, “an embodiment”, and so forth, means that a particular element described in connection with the embodiment is included in at least one embodiment described herein, and may or may not be present in other embodiments. In addition, it is to be understood that the described elements may be combined in any suitable manner in the various embodiments. A “combination thereof” is open and includes any combination comprising at least one of the listed components or properties optionally together with a like or equivalent component or property not listed.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Although the support platforms, systems and methods of the present disclosure have been described with reference to exemplary embodiments thereof, the present disclosure is not limited to such exemplary embodiments and/or implementations. Rather, the support platforms, systems and methods of the present disclosure are susceptible to many implementations and applications, as will be readily apparent to persons skilled in the art from the disclosure hereof. The present disclosure expressly encompasses such modifications, enhancements and/or variations of the disclosed embodiments. Since many changes could be made in the above construction and many widely different embodiments of this disclosure could be made without departing from the scope thereof, it is intended that all matter contained in the drawings and specification shall be interpreted as illustrative and not in a limiting sense. Additional modifications, changes, and substitutions are intended in the foregoing disclosure. Accordingly, it is appropriate that the appended claims be construed broadly and in a manner consistent with the scope of the disclosure.

What is claimed is:

1. A method of fabricating a mattress support platform comprising:
providing a core material;
positioning a first fiber-based substrate on a first side of the core material and positioning a second fiber-based substrate on a second side of the core material;
spraying an application material to the first and second fiber-based substrates; and
molding the application material to form a vehicular mattress support platform.

2. The method of claim 1, wherein the core material is a paper core honeycomb material.

3. The method of claim 1, wherein the core material has a thickness of from about 20 mm to about 50 mm.

4. The method of claim 1, wherein the core material has a variable thickness.

5. The method of claim 1, wherein the first and second fiber-based substrates each have a thickness of from about 0.5 mm to about 3 mm.

6. The method of claim 1, wherein the core material is a paper core honeycomb material with a pre-determined cell size.

7. The method of claim 1, wherein the first and second fiber-based substrates are random glass fiber-based substrates or continuous glass fiber-based substrates.

8. The method of claim 1, wherein the first and second fiber-based substrates are glass fiber-based substrates having variable glass fiber content.

9. The method of claim 1, wherein the application material comprises a pre-polymer material.

10. The method of claim 1, wherein the application material comprises urethane.

11. The method of claim 1, wherein the application material comprises a resin.

12. The method of claim 1, wherein the application material is compression molded to form the vehicular mattress support platform.

13. The method of claim 1 further comprising curing the application material to form the vehicular mattress support platform.

14. The method of claim 1, wherein at least a portion of the application material penetrates the first and second fiber-based substrates.

15. The method of claim 1, wherein the vehicular mattress support platform comprises at least one attachment location for an attachment member.

16. The method of claim 1, wherein the first and second fiber-based substrates each comprises at least one of glass fibers, carbon fibers, or natural fibers, or a combination thereof.

17. A mattress support platform comprising:
a first fiber-based substrate positioned on a first side of a core material and a second fiber-based substrate positioned on a second side of the core material; and
a spray applied application material on the first and second fiber-based substrates, the spray applied application material molded to form a vehicular mattress support platform.

18. The mattress support platform of claim 17, wherein the core material is a paper core honeycomb material.

19. The mattress support platform of claim 17, wherein the first and second fiber-based substrates each comprises at least one of glass fibers, carbon fibers, or natural fibers, or a combination thereof.

20. The mattress support platform of claim 17, wherein the application material comprises a pre-polymer material.
